(19) United States
(12) Patent Application Publication
(10) Pub. No.: US 2021/0180401 A1
(43) Pub. Date: Jun. 17, 2021

(54) MOSQUITO NET STRUCTURE

(71) Applicant: LCI ITALY S.R.L., Florence (IT)

(72) Inventor: Maurizio PIERAMICI, Torrita di Siena ( Siena ) Toscana (IT)

(21) Appl. No.: 17/123,374

(22) Filed: Dec. 16, 2020

(30) Foreign Application Priority Data
Dec. 16, 2019 (IT) 102019000024168

(51) Int. Cl. E06B 9/52; A01M 29/34; B60J 11/08

(52) U.S. Cl. CPC E06B 9/52; B60J 11/08; A01M 29/34

(57) ABSTRACT

A mosquito net structure for compartments having a triangular portion includes a first insect screen for protecting against insects by closing a triangular portion, a first fixed frame defining a hypotenuse of the triangle, the first insect screen being rigidly attached to the first fixed frame at a relative first perimeter edge, and a first movable handle-bar rigidly connected to a second perimeter edge of the first protective insect screen.

### CROSS-REFERENCES TO RELATED APPLICATIONS

This application claims priority of Italian Patent Application No. 102019000024168 filed Dec. 16, 2019, the entire contents of which are hereby incorporated by reference in this application.

### BACKGROUND

This invention relates to a mosquito net structure.

More specifically, this invention relates to a mosquito net structure for compartments of doors or windows of recreational vehicles, such as campervans or caravans.

Yet more specifically, the invention relates to a mosquito net structure for recreational vehicles designed to protect compartments of doors or windows with a non-rectangular shape.

Mosquito nets, meaning the dense mesh insect screens designed to prevent the passage of even small insects, are normally used in recreational vehicles since they are normally used in places (near the sea or lakes) and during periods of the year (in the summer) when the presence of insects such as, for example, flies and mosquitoes is particularly widespread and annoying.

In order to be practical to use, the mosquito nets are usually mounted on special supporting structures which are able to allow a quick opening and closing, so that it is not difficult to use the compartment on which they are fitted to protect.

The most widespread prior art mosquito net structures generally consist of a quadrangular frame with right-angled corners located at the opening of the doors or windows and having a box-shaped crosspiece (also called the box) inside of which is housed an elastic rewinding roller to which is connected a first end of an insect screen designed to prevent the passage of insects. A second end of this insect screen, opposite the first end, is also connected to a handle-bar which is movable relative to the roller. The relative movement for moving the handle-bar away from/towards the compartment determines the unwinding and, respectively, the rewinding of the insect screen of the mosquito net.

As an alternative to the mosquito nets just described with a winding roller, there are widespread mosquito nets comprising pleated insect screens which, when not used to protect the compartment, are closed in a pack at a side wall of the frame.

The prior art mosquito net structures described above are substantially constrained, in terms of their shape, to rectangular forms and, although this does not constitute a particular limitation in the case of houses, it is, on the other hand, in the context of recreational vehicles where designers favour a greater freedom in the design of door and window openings.

### SUMMARY

An objective of the described embodiments is to provide a mosquito net structure which allows the limits indicated above to be overcome, allowing the protection of compartments and openings having a non-rectangular shape.

A further objective of the described embodiments is to provide a mosquito net structure which is practical and effective to operate and simple to use.

Yet another objective of the described embodiments is to provide a mosquito net structure which is simple and inexpensive to manufacture.

### BRIEF DESCRIPTION OF THE DRAWINGS

Further features and advantages are more apparent in the detailed description which follows, with reference to the accompanying drawings which illustrate a non-limiting example embodiment in which:

FIG. 1 is a schematic front elevation view of a mosquito net structure made according to the described embodiments;

FIG. 2 is a schematic front elevation view of the mosquito net structure of FIG. 1 in a different configuration of use;

FIG. 3 is an exploded schematic view of the mosquito net structure of the preceding drawings;

FIGS. 4 to 6 are schematic scaled-up perspective views of details of the mosquito net structure of FIG. 3.

### DETAILED DESCRIPTION

With reference to the accompanying drawings, the numeral denotes in its entirety a mosquito net structure made according to the described embodiments.

The mosquito net structure 1, for sake of brevity also referred to simply as structure 1, is particularly designed to protect compartments, such as doors or windows, of recreational vehicles such as campervans or caravans.

The structure 1 of the mosquito net according to the described embodiments is in particular designed to protect compartments having a triangular portion T, labelled with a dashed line in FIG. 2.

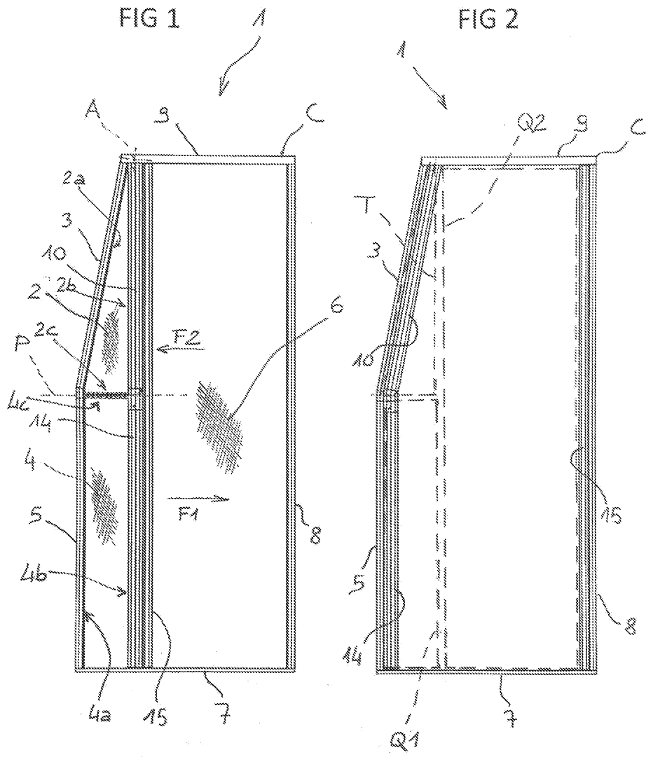

As illustrated in FIG. 1, the mosquito net structure 1 comprises a first insect screen 2 for protection against insects designed to be positioned for closing the above-mentioned triangular portion.

The first protective insect screen 2 is advantageously of the pleated type, that is to say, having a plurality of pleats in the form of bellows.

The mosquito net structure 1 comprises a first fixed frame 3 defining a hypotenuse of the triangle defining the above-mentioned portion T, the first fixed frame 3 being stably connected to the first insect screen 2 at a first perimeter edge 2a of the latter.

The mosquito net structure 1 comprises a second insect screen 4 for protecting against insects which is designed to be positioned for closing a portion of the compartment in the shape of a rectangle (denoted schematically in FIG. 2 with a rectangular dashed portion Q1) adjacent to the above-mentioned portion T in the shape of a triangle.

The structure 1 has a fixed second frame 5 defining a vertical side of the above-mentioned rectangle Q1.

The second insect screen 4 is stably connected to the second fixed frame 5 at its first perimeter edge 4a.

According to the embodiment illustrated in the accompanying drawings, the mosquito net structure 1 comprises a third insect screen 6 for protecting against insects which is designed to be positioned for closing a respective portion of the compartment in the shape of a rectangle (indicated schematically in FIG. 2 with a rectangular dashed portion Q2) adjacent to both the portions T and Q1 described above.

The structure 1 comprises a plurality of perimeter profiled sections 7, 8, 9 which, together with the above-mentioned first and second frames 3, 5, define for the structure 1 a respective perimeter frame C.

The structure 1 comprises a first movable handle-bar 10, rigidly constrained to a second perimeter edge 2b of the above-mentioned first protective insect screen 2.

In the specific field of mosquito nets, the term handle-bar means a profile, generally made of aluminium or rigid plastic material, attached to the insect screen and used for opening or closing the insect screen, preferably with the function of hooking or in any case blocking the mosquito net in one or more different configurations.

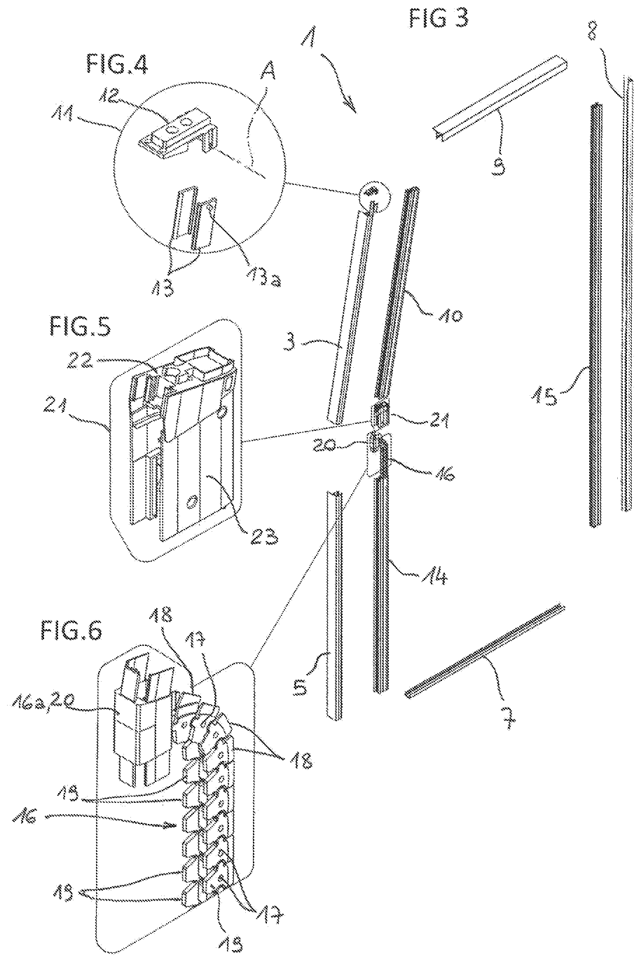

As better illustrated in FIGS. 3 and 4, the mosquito net structure 1 comprises a joint 11 slidably engaged with the above-mentioned first handle-bar 10 at a relative upper end zone 11a, and at the same time defining a pivot, fixed relative to the first frame 3, for rotating the first handle-bar 10.

With reference in particular to FIG. 4, the joint 11 comprises a main body 12 designed to connect rigidly and stably both to the first frame 3 and to the perimeter profile 9 of the frame C, and two skids 13.

The two skids 13 are pivoted with relative pins 13a (only one of which is visible in FIG. 4) in respective holes made on the main body 12, so as to oscillate about a shared axis A perpendicular to the plane of FIG. 1.

The two skids 13 are slidably engaged in relative grooves made on opposite outer faces of the profile forming the first handle-bar 10.

The above-mentioned grooves, even though not specifically indicated, can be seen by viewing handle-bar 10, as illustrated, for example, in FIG. 3.

The joint 11 with its main body 12 and skids 13 defines, for the mosquito net structure 1, respective means for linking in a roto-translating manner the first handle-bar 10 relative to the first frame 3, configured to allow the first handle-bar 10 to rotate about the above-mentioned fulcrum axis A fixed relative to the first frame 3 and at the same time translate relative to the axis A, to move from a first closed configuration, illustrated in FIG. 2, wherein the first handle-bar 10 is positioned adjacent to the fixed first frame 3 and a second open configuration wherein the first protective insect screen 2 extends for covering the portion T in the shape of a triangle.

According to the second configuration, the first handle-bar 10, like the second perimeter edge 2b connected to it, defines a first leg of the triangle defined by the portion T.

As illustrated in FIG. 1, the first protective insect screen 2 has a third lower perimeter edge 2c which, in the above-mentioned second configuration illustrated in FIG. 1, defines a second leg of the triangle defined by the portion T.

With reference to the accompanying drawings, the structure 1 comprises a second movable handle-bar 14, rigidly constrained to a second perimeter edge 4b of the second protective insect screen 4.

The second handle-bar 14 is connected to said first handle-bar 10 and is designed to move from a first closed configuration, illustrated in FIG. 2, in which it is positioned adjacent to the second fixed frame 5 and a second open configuration, illustrated in FIG. 1, wherein the second protective insect screen 4 extends to cover the above-mentioned portion Q1 in the shape of a rectangle.

As illustrated in FIGS. 1 and 2, the embodiment of the structure 1 comprises a third movable handle-bar 15 constrained rigidly to a first perimeter edge 6a of the third protective insect screen 6.

The third bar handle-bar 15 is designed to move from a first closed configuration, illustrated in FIG. 2, in which it is positioned adjacent to the perimeter profile 8 and a second open configuration, illustrated in FIG. 1, wherein the third protective insect screen 6 extends for covering the above-mentioned portion Q2 in the shape of a rectangle.

A second perimeter edge of the third protective insect screen 6, opposite and parallel to the first perimeter edge 6a, is stably fixed to the perimeter profile 8.

As illustrated in FIGS. 1, 3 and 6, the mosquito net structure 1 comprises a chain 16 for guiding the above-mentioned third perimeter edge 2c of the first protective insect screen 2.

The net-guiding chain 16, shown in detail in FIG. 6, comprises a succession of interconnected modular elements 17.

The guide chain 1 is configured for also guiding a third horizontal perimeter edge 4c of the second protective insect screen.

The above-mentioned third perimeter edges 2c, 4c of the first insect screen 2 and of the second insect screen 4 extend substantially parallel to each other in the open configuration of the insect screens 2, 4 illustrated in FIG. 1.

For this purpose, that is to say, for guiding both the third edges 2c, 4c of the first and second protective insect screens 2, 4, the interconnected modular elements 17 of the chain 16 have upper and lower wings 18, 19, designed to contain and guide, respectively, the first protective insect screen 2 and the second protective insect screen 4.

As clearly illustrated in FIG. 6, the upper and lower wings 18, 19 are located on opposite sides of a sliding plane P of the chain 16, shown in FIG. 1 and representing a dividing line between the triangular portion T and the rectangular portion Q1 located below.

As illustrated in detail in FIG. 6, each modular element 17 has a pair of upper wings 18 and a pair of lower wings.

The upper wings 18 and the lower wings 19 together define, when the respective modular elements 17 are positioned parallel to the above-mentioned sliding plane P, two respective guiding channels for the first and second insect screens 2, 4 and, in particular, their third edges 2c, 4c.

Again with reference to FIG. 6, according to the preferred embodiment illustrated and described, the chain 16 has a first end 16a designed to be stably attached to the first and second frames 3, 5.

Advantageously, again according to the preferred embodiment illustrated, the above-mentioned first end 16a of the chain 16 defines an element 20 for stably linking the above-mentioned first fixed frame 3 and second fixed frame 5.

Advantageously, the linking element 20 defines the reciprocal inclination between the above-mentioned first 3 and second 5 fixed frames, thereby also defining the inclination of the hypotenuse of the triangle identified by the portion T.

The net-guiding chain 16 has a second end 16b, shown in FIG. 1, slidable inside the second handle-bar 14 together with the modular elements 17 adjacent to it.

As illustrated in the accompanying drawings and in detail in FIG. 5, the mosquito net structure 1 comprises an element 21 for linking between the first handle-bar 10 and the second handle-bar 14.

The linking element 21 comprises a first upper portion 22 integral with the first handle-bar 10 and a second, lower portion 23 integral with the second handle-bar 14, with the first and second portions 22, 23 pivoted to each other to rotate relative to each other.

In other words, the first handle-bar 10 and the second handle-bar 14 are articulated to each other at the above-mentioned linking element 21, to form a sort of single articulated handle-bar.

Advantageously, the mosquito net structure 1 comprises, not shown in the accompanying drawings, net-guiding chains 16 made in the above-mentioned lower portion 23 of the linking unit 21, designed to facilitate recovery of the chain 16 inside the box-shaped profile defining the second handle-bar 14.

In use, starting from the configuration illustrated in FIG. 1, where all the three protective insect screens 2, 4, 6 are extended to cover the respective portions T, Q1, Q2 of the compartment, the user wishing to free the compartment for example to pass through it, advantageously grips the third handle-bar 15 and slides it, parallel with itself, in the direction indicated by the arrow F1, until coming into contact with the vertical profile 8, as illustrated in FIG. 2.

Following this movement, the third protective insect screen 6, advantageously of the pleated type, is closed in a pack and adopts a completely negligible overall size between the third handle-bar 15 and the vertical profile 8.

Magnetic retaining elements, not illustrated, can help to ensure that this position is stably maintained.

With reference to the configuration illustrated in the drawings of the first 10 and second 14 handle-bars, the user pushes them, advantageously gripping the linking element 21 which joins them, in the direction of the arrow F2.

The first effect of this pushing action is to generate a roto-translation of the first handle-bar 10 which, thanks to the above-mentioned joint 11, simultaneously rotates about the axis A and translates relative to its main direction of extension, until it is substantially superposed on the first fixed frame 3, as illustrated in FIG. 2.

In essence, the above-mentioned roto-translation allows the handle-bar 10 to be superposed on the first fixed frame 3, compensating for the difference in length between the leg and hypotenuse of the triangle.

Following the movement of the first handle-bar 10 described above, the first protective insect screen 2, advantageously of the pleated type, closes together in a pack and adopts a completely negligible size between the first handle-bar 10 and the first fixed frame 3.

Simultaneously with the movement of the first handle-bar 10, the user, who has gripped the linking element 21 and is pushing in the direction indicated by the arrow F2, causes the second handle-bar 14 to slide until it is in contact with the second fixed frame 5 substantially superposed thereon.

Similarly to what has already occurred with the third insect screen 6 and the first insect screen 2, the second protective insect screen 4, advantageously of the pleated type, is closed in a pack and adopts a completely negligible overall size between the second handle-bar 10 and the second fixed frame 3.

The mosquito net structure according to the described embodiments achieves the preset aims and brings important advantages.

A first advantage is due to the possibility of allowing an extremely versatility in the protection against insects for compartments which have a shape different from rectangular or square.

Thanks to the mosquito net structure according to the described embodiments it is in fact possible to protect a wide range of shapes, for example, from the composition of triangular and rectangular portions.

According to alternative embodiments, not illustrated, there may also be protected compartments with curved portions, for example forming the first fixed curved frame. Another advantage is due to the relative simplicity both in terms of construction and use.

Advantageously, the mosquito net structure according to the described embodiments can be used with a wide range of transport vehicles, even, for example, buses.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. Mosquito net structure for compartments with a triangular portion (T), including:
a first insect screen designed to provide protection against insects by closing a triangular section (T),
a first fixed frame defining a hypotenuse of said triangle, said first insect screen being permanently bound to said first fixed frame in correspondence of its own first perimetral edge,
a first movable handle rigidly attached to a second perimeter edge of said first protective net,
roto-translating connecting means for connecting said first handle-bar and said first frame, configured to allow the first handle-bar to rotate around a fixed fulcrum (A) with respect to said first fixed frame and at the same time to translate with respect to said first fixed frame, to move from a first closed configuration in which said first handle-bar is placed adjacent to said first fixed frame and a second open configuration in which said first insect screen extends to cover said triangular portion (T).

2. Mosquito net structure according to claim 1, in which said first handle-bar defines a first cathetus of said triangle, wherein it comprises a net-guiding chain for guiding a third perimetral edge of said first insect screen, said net-guiding chain comprising a series of interconnected modular elements.

3. Mosquito net structure according to claim 1, wherein said roto-translating connecting means comprise a joint slidably engaged with said first handle-bar and simultaneously defining a fulcrum (A) fixed with respect to said first fixed frame, said first handle-bar sliding in relation to said joint in the transition between said first and second configuration.

4. Mosquito net structure according to claim 3, in which said first handle-bar comprises a metal box profile with two longitudinal grooves, wherein said joint includes a main body attached to said first fixed frame and two skids slidably engaged in said longitudinal grooves of said first handle-bar and simultaneously pivoted into said main body.

5. Mosquito net structure according to claim 2, comprising a second insect screen to be arranged to close a portion (Q1) of the compartment in the shape of a rectangle adjacent to said portion (T) of the compartment in the shape of a triangle, and a second fixed frame defining one side of said rectangle, said second insect screen being permanently bound to said second fixed frame in correspondence of its first perimetral edge, wherein it comprises a second mobile handle-bar, rigidly bound to a second perimetral edge of said second insect screen, said second handle-bar being connected to said first fixed handle-bar and being able to move from a first closed configuration in which it is placed adjacent to said second fixed frame and a second open configuration in which said second insect screen extends to cover said portion (T) in the shape of a rectangle.

6. Mosquito net structure according to claim 5, wherein said net-guiding chain of said third perimetral edge of said first insect screen net is configured to also guide a third perimetral edge of said second insect screen, said third perimetral edges of said first and second insect screens extending substantially parallel to each other.

7. Mosquito net structure according to claim 5, wherein said interconnected modular elements of said net-guiding chain have two pairs of wings each designed to contain a respective insect screen, said pairs of wings being arranged by opposite bands with respect to a sliding plane of said net-guiding chain.

8. Mosquito net structure according to claim 6, wherein said net-guiding chain has a first end permanently secured to at least one among said first and second fixed frames, first and second handle-bar, and a second end sliding inside another one among said first and second fixed frames, first and second handle-bar.

9. Mosquito net structure according to claim 5, in which said second handle-bar moves between said first and second configuration keeping substantially parallel to said second fixed frame, wherein said first and second handle-bar are infulcrated to each other to allow said first handle-bar to rotate relatively to said second handle-bar in the movement between the respective first and second configuration.

10. Mosquito net structure according to claim 8, wherein it comprises a linking element connecting said first and second handle-bar, said linking element comprising a first portion integral to said first handle-bar and a second portion integral to said second handle-bar, said first and second portion being pivoted between them.
